(19) United States
(12) Patent Application Publication
(10) Pub. No.: US 2019/0316989 A1
(43) Pub. Date: Oct. 17, 2019

(54) FAULT PREDICTION METHOD FOR PLANT

(71) Applicant: FUTUREMAIN CO., Ltd, Suwon (KR)

(72) Inventor: Shin Hye LEE, Suwon (KR)

(73) Assignee: FUTUREMAIN CO., Ltd, Suwon (KR)

(21) Appl. No.: 15/954,141

(22) Filed: Apr. 16, 2018

(51) Int. Cl. G01M 13/00

(52) U.S. Cl. CPC G01M 13/00; G01M 13/045

(57) ABSTRACT

Disclosed is a method of predicting a plant fault including: defining a rotary machine elements for predicting a fault determination among plant components; defining a fault type and a fault condition of each of the rotary machine elements; classifying and coding the fault condition of the rotary machine element into a fabrication and installation condition, a load condition, a lubrication condition, and an environment and operation condition; associating the fault type of the rotary machine element with code values of the four fault conditions and storing the association in a database; receiving status information on the fault condition of the rotary machine element for predicting a fault from a user; and determining the fault type corresponding to a combination of the code values of the received fault conditions. Complex factors in the fault possibly caused in the plant is predicted more clearly beyond simple defect detection.

### BACKGROUND OF THE INVENTION

### 1. Field of the Invention

The present invention relates to a method of predicting fault of plant, and more particularly, to a method of predicting fault of plant, in which fault occurrence conditions of machine elements are classified into various conditions, thereby predicting complex fault types based on the combination of the fault occurrence conditions rather than simply detecting a defect according to the fault occurrence condition of each machine element frequently having a breakdown among major machine elements of the plant widely used in the industrial field.

### 2. Description of the Related Art

In general, a method of predicting fault of plant required to be stably and continuously operated in the industrial field has been researched and developed to prevent a sudden breakdown causing fatal damage to the plant line, and prevent a decrease of production caused by the cease of the plant line due to an unexpected fault.

A currently used fault prediction method employs a scheme of determining a state of plant or a component and predicting a lifespan by sensing changes of an abnormal state of the plant, and detecting defects appearing at this time.

According to the above prediction method, changes of vibration, heat, or a current in the case of a motor are measured and the minute state changes in the plant are compared with a preset reference value, so that the deterioration state of the plant is determined and the defect is predicted. However, only changes in a fragmentary symptom according to the state changes of the plant can be determined.

In addition, a method of detecting changes in the amount of vibration generated in plant to predict a plant fault merely figures out an increase of the vibration, and changes of load or operation speed, which are the fundamental factor causing the vibration, cannot be figured out. In particular, since it is difficult to find the cause of the state change due to complex factors, the fault cannot be accurately predicted.

Further, in the case of a motor, if the change in the vibration amount exceeds a predetermined vibration reference when an electromagnetic vibration increases, it is found that the plant is in an unstable state. However, it cannot be predicted whether the increase in the vibration amount will cause an electrical fault or a mechanical fault of the motor. In other words, although the changes of the vibration amount may well reflect the change of the machine condition, it is very difficult to predict the fault on the basis of the changes.

Accordingly, demands for a fault prediction method have been increased to overcome the problem of the conventional method of predicting a plant fault, and predict a complex plant fault rather than predict a simple defect so as to improve the reliability.

### SUMMARY OF THE INVENTION

According to the present invention, a fundamental factor for a change of a plant state is identified by analyzing whether the change of the plant state is caused by a deterioration due to a simple vibration, caused by an installation defect, or caused by a load variation during operation, thereby predicting a fault of a machine caused by a change of a current state, in other words, predicting a fault type due to complex factors rather than simply detecting a defect.

To this end, according to an aspect of the present invention, the method includes: a first step of receiving definitions for rotary machine elements for predicting a fault among plant components; a second step of receiving definitions for fault types and fault occurrence conditions of each of the rotary machine elements; a third step of classifying and coding the fault occurrence conditions of each of the rotary machine elements into predetermined categories; a fourth step of associating the fault type of each rotary machine element with a combination of code values of the fault occurrence conditions and storing the result in a database; a fifth step of receiving status information on the fault condition of the rotary machine element for predicting a fault from a user; and a sixth step of determining the fault type corresponding to a combination of the code values of the received fault conditions.

Further, the predetermined categories comprises a fabrication and installation conditions, a load condition, a lubrication condition, and an environment and operation condition.

Further, the fifth step comprises displaying subject plant options and receiving a user input; generating an input code according to a previous user input for subject plant options; displaying fabrication and install conditions according to the previous input code; updating the input code according to a previous user input for fabrication and install conditions; displaying load conditions according to the previous input code; updating the input code according to a previous user input for load conditions; displaying lubrication conditions according to the previous input code; updating the input code according to a previous user input for lubrication conditions; displaying environment and operation conditions according to the previous input code; and updating the input code according to a previous user input for environment and operation conditions.

Further, the sixth step comprises determining the fault type according to the final updated input code.

Further, the step of receiving the status information on the fault occurrence condition of the rotary machine element for predicting the fault from the user includes sequentially receiving state information on the fabrication and installation condition, the load condition, the lubrication condition, and the environment and operation condition.

According to the present invention as described above, in addition to changes of a plant state, all of an installation condition, a change of a load condition during an operation, a change of a lubrication and operation condition, and the like are considered and combined, so that complex factors in the fault possibly caused in the plant can be predicted more clearly beyond simple defect detection.

### BRIEF DESCRIPTION OF THE DRAWINGS

FIG. 1 is a flowchart illustrating a process for performing a method of predicting plant fault according to the present invention.

FIG. 2 is a flowchart illustrating a process for receiving a fault occurrence condition according to the present invention.

FIG. 3 is a view illustrating a mechanism of generating spalling of an anti-friction bearing.

FIG. 4 is a flowchart illustrating a process for receiving a fault occurrence condition according to the present invention.

FIG. 5 to FIG. 10 are views illustrating examples of a fault prediction sequence of an anti-friction bearing according to combinations of fault occurrence conditions.

### DETAILED DESCRIPTION OF THE INVENTION

Hereinafter, a preferred embodiment of the present invention will be described in detail with reference to the accompanying drawings.

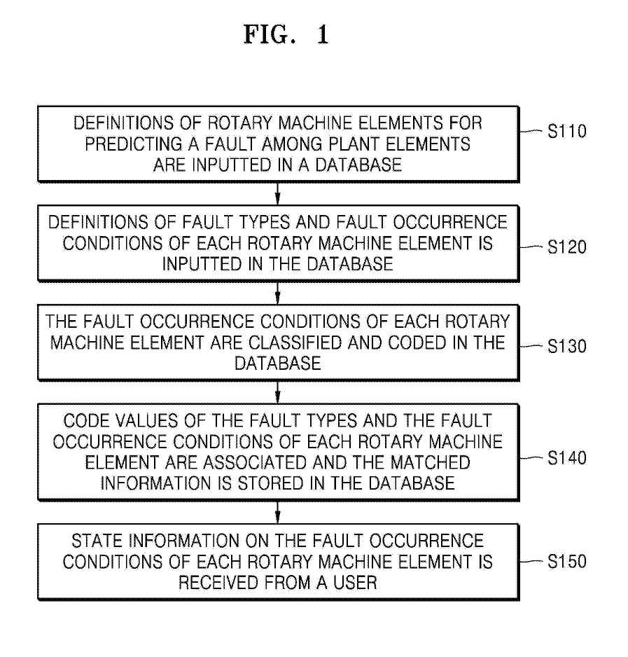

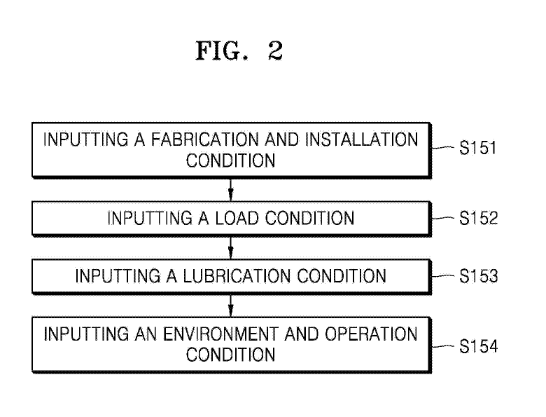

FIG. 1 is a flowchart illustrating a process for performing a method of predicting plant fault according to the present invention. FIG. 2 is a flowchart illustrating a process for receiving a fault occurrence condition according to the present invention.

Definitions of rotary machine elements for predicting a fault among plant elements are inputted in a database in a computing device which comprises one or more memories and one or more processors (S110).

According to the present invention, a bearing, a seal, a coupling, a motor, a pump, a fan, and the like, which are widely used in the industrial field and frequently have a breakdown, are defined as the major machine elements for determining the fault.

In addition, definitions of fault types and fault occurrence conditions of each rotary machine element is inputted in the database (S120). In addition, The fault occurrence conditions of each rotary machine element are classified and coded into one of a fabrication and installation condition, a load condition, a lubrication condition, and an environment and operation condition, in the database (S130).

Herein, the fault types and code values of the fault occurrence conditions of each rotary machine element are associated or matched, and the matched information is stored in the database (S140).

Then, status information on the fault occurrence condition of the rotary machine element is received for predicting the fault from a user (S150).

Then, the fault type or the degree of fault corresponding to a combination of the code values of the received fault occurrence conditions is determined (S160).

The above four fault occurrence conditions in each of the rotary machine elements are classified into a condition related to fabrication and installation of the plant, a load condition changed during operation of the plant, a lubrication condition directly exerting an impact on a bearing defect, and an environment and operation condition impacted by a long time or an over speed.

The above four fault occurrence conditions are re-classified to provide detailed conditions that may cause fault occurrence conditions.

The detailed conditions include a performance parameter which may be generated by a performance change of the plant and a state parameter for figuring out a state of the plant, thereby simultaneously detecting a defect due to the state change and detecting a defect due to the performance change, so that the fault type can be clearly and specifically predicted, and the reliability of the fault prediction can be improved.

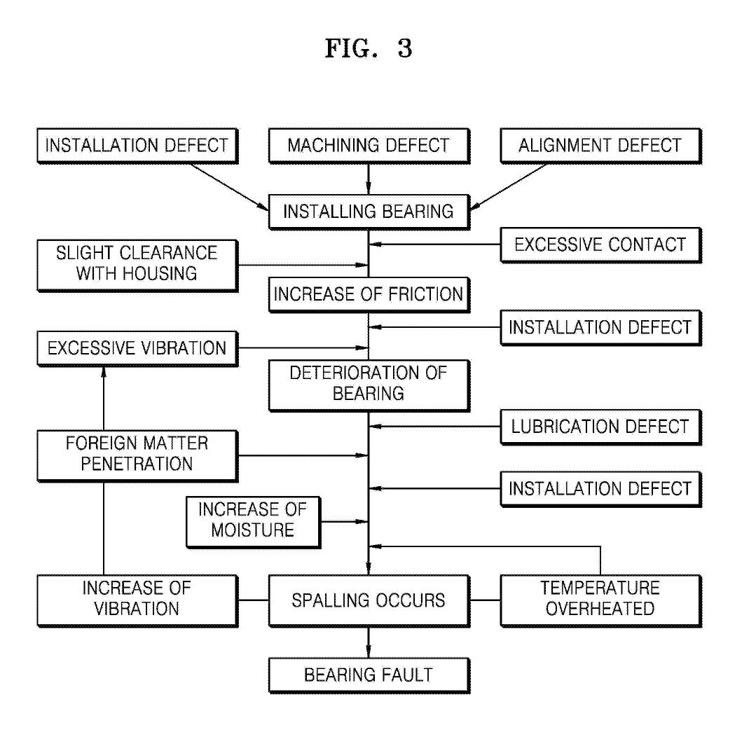

As shown in FIG. 3 illustrating a mechanism of generating spalling of an anti-friction bearing, a fault is caused by various factors according to changes in the performance or the state of the anti-friction bearing itself, not by just one factor. Thus, in the present invention as described above, the fault occurrence conditions are specifically classified, so that the prediction can be performed more accurately.

The tables below define rotary machine elements for determining the fault and then define the fault types and fault occurrence conditions of each of the machine elements (S120), and an anti-friction bearings and a gear are illustrated in the tables.

<Example of Fault Types and Fault Occurrence Conditions in Anti-Friction Bearing>

| | Fault occurrence condition | | | | |
|---|---|---|---|---|---|
| Fault | Fabrication and | Load | Lubrication | Operation | Fault |
| type | installation condition | condition | condition | condition | mechanism |
| Spalling | [symbol] Installation defect | [symbol] Excessive load | [symbol] Lubrication defect | [symbol] High-speed operation | The load is applied |
| | [symbol] Alignment defect | [symbol] Excessive vibration | [symbol] Foreign matter | [symbol] Humid environment/ | to a place having a |
| | [symbol] Bearing clearance | | penetration | [symbol] Potential difference | surface cracks of the |
| | nonconformity | | | occurrence | bearing, so that |
| | [symbol] Accuracy defect of | | | | the surface is rapidly |
| | shaft and housing | | | | peeled off and has a |
| | | | | | rough surface. |
| Peeling | [symbol] Machining defect of | [symbol] Repeated load | [symbol] Lubrication defect | [symbol] Normal operation | The load is applied |
| | rotary component | [symbol] Normal load | [symbol] Foreign matter | | to a surface of the |
| | (surface roughness | | penetration | | bearing, so that |
| | defect) | | | | the surface is slightly |
| | | | | | peeled off, and the |
| | | | | | plating processed on the |
| | | | | | surface is peeled off. |
| Smearing | [symbol] Assembly defect | [symbol] High speed and | [symbol] Lubrication defect | [symbol] High-speed operation | Minute dissolution matter |
| | [symbol] Tolerance defect | light load | [symbol] Foreign matter | | caused by slipperiness |
| | [symbol] Preload defect | | penetration | | and oil film destruction |
| | | | | | due to rolling generates |
| | | | | | surface roughness |
| | | | | | accompanying surficial |
| | | | | | welding on an orbital |
| | | | | | surface or an operating |
| | | | | | surface of the bearing |
| | | | | | due to a burn phenomenon. |
| Fracture | [symbol] Handling defect | [symbol] Excessive load | [symbol] Lack of lubrication | [symbol] Frequent operation | A sill or a roller |
| | [symbol] Installation defect | [symbol] Impulse load | [symbol] Metal component | [symbol] Cease operation | edge of an orbital |
| | | | penetration | [symbol] Normal operation | wheel is partially |
| | | | | | broken and separated |
| | | | | | due to local impact or |
| | | | | | overload. |

<Example of Fault Types and Fault Occurrence Conditions in Gear>

| | Fault occurrence condition | | | | |
|---|---|---|---|---|---|
| | Fabrication and | | | | |
| Fault | installation | Load | Lubrication | Operation | Fault |
| type | condition | condition | condition | condition | mechanism |
| Wear | [symbol] Material defect | [symbol] Excessive load | [symbol] Lubrication defect | [symbol] Normal operation | Because an insufficient |
| | [symbol] Tooth defect | [symbol] Repeated load | [symbol] Foreign matter | [symbol] High- speed | thickness of the oil |
| | | | penetration | operation | film due to the lubrication |
| | | | [symbol] Viscosity defect | | defect causes a wear, an |
| | | | | | end or a tooth root |
| | | | | | region is worn out at |
| | | | | | a relative slippery |
| | | | | | place. |
| Scoring | [symbol] Alignment defect | [symbol] Excessive load | [symbol] Lack of | [symbol] High-speed operation | melting and cracking separation |
| | | [symbol] Impulse load | lubrication | | are consistently generated |
| | | [symbol] Excessive contact | [symbol] Metal component | | in a region where the oil film |
| | | | penetration | | is thin due to the lack of lubrication, |
| | | | | | thereby resulting in local scratches. |
| | | | | | In particular, the scratches |
| | | | | | are generated when a high load is |
| | | | | | locally applied upon misalignment |
| | | | | | between machines. |
| Breakage | [symbol] Fabrication defect | [symbol] Excessive load | [symbol] Viscosity defect | [symbol] Normal operation | It occurs when an over load |
| | [symbol] Installation defect | [symbol] Impulse load | [symbol] Metallic foreign | | exceeds the expected |
| | [symbol] Material defect | | matter penetration | | design load, and |
| | | | | | when a sudden misalignment |
| | | | | | or a bearing breakage |
| | | | | | occurs, or when |
| | | | | | external foreign |
| | | | | | matter is stuck |
| | | | | | between tooth surfaces. |
| Plastic | [symbol] Assembly defect | [symbol] Excessive load | [symbol] Oil film thickness | When the rolling | |
| Flow | [symbol] Material defect | [symbol] Repeated load | defect | and sliding movement | |
| | | | [symbol] Lack of lubrication | is repeated while the | |
| | | | [symbol] Normal operation | gear tooth | |
| | | | | surface is being | |
| | | | | under high contact | |
| | | | | stress, a plastic | |
| | | | | flow phenomenon occurs | |
| | | | | while the contact | |
| | | | | surface breaks down or | |
| | | | | deforms. | |

As described above, the fault types and the fault occurrence conditions of each of the rotary machine elements are defined (S120), and then state information is defined and coded for each of the four fault occurrence conditions of the machine elements (S130).

As shown in the following table, the status information according to the fault occurrence conditions of the machine elements are encoded in sequence.

<Example of Coding of Fault Occurrence Condition of Anti-Friction Bearing>

| Fabrication | | | |
|---|---|---|---|
| and | | | Environment and |
| installation | | Lubrication | operation |
| condition | Load condition | condition | condition |
| 1. Machining | 1. Impulse load | 1. Lack of | 1. High-speed |
| defect | | lubrication | operation |
| (roundness) | | | |
| 2. Tolerance | 2. Excessive | 2. Viscosity | 2. Frequent |
| defect | load, Repeated | defect | operation |
| (Excessive | load | | start/stop |
| large/small | | | |
| clearance) | | | |
| 3. Assembly | 3. Excessive load | 3. Lubrication | 3. Temperature |
| and | at stop | defect | increase |
| installation | | | |
| defect | | | |
| 4. Material | 4. Excessive | 4. Foreign matter | 4. Overheat |
| selection | contact | and metal | |
| defect | | component | |
| | | penetration | |
| 5. | 5. Slight contact | 5. Moisture | 5. High humidity |
| Rotational | | penetration | |
| shaft defect | | | |
| 6. Preload | 6. Excessive | 6. Normal | 6. Potential |
| defect | vibration | lubrication | difference |
| | | | occurrence |
| 7. Seal | 7. Noise | | 7. Normal |
| defect | occurrence | | operation |
| 8. Alignment | 8. Oxidation, | | |
| defect | rust | | |
| 9. Storage | 9. Normal load | | |
| status and | | | |
| handling | | | |
| defect | | | |
| 10. Normal | | | |
| installation | | | |

<Example of Coding of Fault Occurrence Condition of Gear>

| Fabrication | | | |
|---|---|---|---|
| and | | | Environment and |
| installation | | Lubrication | operation |
| condition | Load condition | condition | condition |
| 1. Machining | 1. Impulse load | 1. Lack of | 1. High-speed |
| defect | | lubrication | operation |
| (precision) | | | |
| 2. Tolerance | 2. Excessive | 2. Viscosity | 2. Frequent |
| defect | load, Repeated | defect | operation |
| | load | | start/stop |
| 3. Assembly | 3. High speed and | 3. Lubrication | 3. Temperature |
| and | light load | defect | increase |
| installation | | | |
| defect | | | |
| 4. Material | 4. Excessive | 4. Foreign matter | 4. Overheat |
| selection | contact | and metal | |
| defect | | component | |
| | | penetration | |
| 5. | 5. Slight contact | 5. Moisture | 5. High humidity |
| Rotational | | penetration | |
| shaft defect | | | |
| 6. Gear | 6. Excessive | 6. Normal | 6. Potential |
| combination | vibration, | lubrication | difference |
| defect | Impulse vibration | | occurrence |
| 7. Shaft | 7. Noise | | 7. Normal |
| alignment | occurrence | | operation |
| defect | | | |
| 8. Gear | 8. Oxidation, | | |
| resonance | rust | | |
| 9. Storage | 9. Normal load | | |
| state defect | | | |
| 10. Normal | | | |
| installation | | | |

<Example of Coding of Fault Occurrence Condition of Pump>

| Fabrication and | | | Environment |
|---|---|---|---|
| installation | | Lubrication | and operation |
| condition | Load condition | condition | condition |
| 1. Design and | 1. Excessive | 1. Lack of | 1. Cavitation |
| machining defect | load, Liquid | lubrication | of pump/Low |
| | viscosity | | tank |
| 2. Assembly and | 2. High pipe | 2. Lubrication | 2. Air in |
| installation | resistance | defect | intake tube |
| defect | | | |
| 3. Tolerance | 3. Low pipe | 3. Foreign | 3. High |
| defect | resistance | matter in | rotational |
| | | pump/pipe | speed |
| 4. Basic defect | 4. Insufficient | 4. Rotor casing | 4. Low |
| | intake pressure | wear | rotational |
| | | | speed |
| 5. | 5. Blockage of | 5. Contact or | 5. Driving |
| Alignment/coupling | piping valve | rotor detention | motor defect |
| defect | | | |
| 6. Rotational | 6. Piping valve | 6. Bearing | 6. Controller |
| shaft defect | leakage | defect | defect |
| 7. Wrong | 7. Cavitation | 7. Axial | 7. Tank |
| rotational | vortex | leakage | depletion |
| direction | | | |
| 8. Casing twist | 8. Surging water | 8. Normal state | 8. Normal |
| | hammering | | operation |
| 9. Resonance | 9. Excessive | | |
| | vibration noise | | |
| 10. Normal | 10. Normal load | | |
| installation | | | |

<Example of Coding of Fault Occurrence Condition of Reciprocating Compressor>

| Fabrication and | | | Environment |
|---|---|---|---|
| installation | | Lubrication | and operation |
| condition | Load condition | condition | condition |
| 1. Design and | 1. Excessive load | 1. Lack of | 1. Low |
| fabrication | | lubrication | operation |
| defect | | | speed |
| 2. Assembly and | 2. Excessive pipe | 2. Lubrication | 2. High |
| installation | leakage | and lubrication | operational |
| defect (packing) | | system defect | speed |
| 3. Improper | 3. Excessive | 3. Lubrication | 3. Power |
| cylinder | discharge | leakage | supply defect |
| clearance | pressure | | |
| 4. Basic | 4. Excess crank | 4. Foreign | 4. Improper |
| defect/relaxation | internal pressure | matter in | power |
| | | compressor and | |
| | | pipe | |
| 5. Casing twist | 5. Rotor | 5. Dirty air | 5. Driving |
| | detention/ | filter | motor/ |
| | compressor | | component |
| | stuck | | damage |
| 6. Rotational | 6. Loose piston | 6. Abrasive | 6. Controller |
| shaft defect | | matter/corrosive | defect |
| | | gas in air | |
| 7. Alignment and | 7. Pressure pulse | 7. Carbon | 7. Cooling |
| casing defect | | deposition of | system defect |
| | | discharge valve | |
| 8. Resonance of | 8. Insufficient | 8. Piston ring | 8. Valve |
| pipe and casing | opening of | wear/damage | system defect |
| | entrance valve | | |
| 9. Damper | 9. Air filter | 9. Defective | 9. Unloader |
| installation | blockage | bearing | defect |
| defect | | | |
| 10. Normal | 10. Normal load | 10. Normal | 10. Normal |
| installation | | state | operation |

As described above, the state information is coded for each fault occurrence conditions (S130), and the fault types of each machine element are associated with code values of the four fault occurrence conditions and the results are stored in the database.

As shown in the following table, the fault types according to the combination of code values of the respective fault occurrence conditions is defined and stored in the database (S140).

<Combination of Code Values of Fault Type and Fault Occurrence Condition of Anti-Friction Bearing>

| Fabrication | | | Environment | |
|---|---|---|---|---|
| and | | | and | |
| installation | Load | Lubrication | operation | |
| condition | condition | condition | condition | Fault type |
| 3 | 1 | 4 | 4 | Fracture |
| 2 | 2 | 3 | 3 | Fracture |
| 8 | 6 | 1 | 7 | Fracture |
| 2 | 2 | 1 | 7 | Crumble: due |
| | | | | to |
| | | | | elasticity |
| | | | | degradation |
| 4 | 1 | 3 | 4 | Crumble: due |
| | | | | to |
| | | | | elasticity |
| | | | | degradation |
| 3 | 6 | 2 | 4 | Crumble: due |
| | | | | to |
| | | | | elasticity |
| | | | | degradation |
| 1 | 1 | 4 | 4 | Cracking |
| 4 | 2 | 3 | 3 | Cracking |
| 3 | 6 | 1 | 7 | Cracking |
| 3 | 5 | 4 | 3 | Surface |
| | | | | peeling |
| 4 | 2 | 1 | 4 | Surface |
| | | | | peeling |
| 2 | 6 | 3 | 7 | Surface |
| | | | | peeling |
| 8 | 1 | 4 | 4 | Local |
| | | | | peeling |
| 2 | 2 | 3 | 3 | Local |
| | | | | peeling |
| 3 | 4 | 1 | 7 | Local |
| | | | | peeling |
| 3 | 1 | 1 | 7 | Cage damage |
| 2 | 2 | 3 | 1 | Cage damage |
| 1 | 4 | 4 | 1 | Cage damage |
| 9 | 3 | 3 | 7 | Press |
| | | | | indentation, |
| | | | | false |
| | | | | indentation |
| 6 | 6 | 2 | 3 | Press |
| | | | | indentation, |
| | | | | false |
| | | | | indentation |
| 2 | 1 | 1 | 3 | Press |
| | | | | indentation, |
| | | | | false |
| | | | | indentation |
| 2 | 2 | 4 | 7 | Scratch |
| 3 | 1 | 1 | 3 | Scratch |
| 7 | 6 | 3 | 2 | Scratch |
| 2 | 2 | 5 | 6 | Wave pattern |
| | | | | polishing on |
| | | | | orbital |
| | | | | surface |
| 6 | 6 | 1 | 3 | Wave pattern |
| | | | | polishing on |
| | | | | orbital |
| | | | | surface |
| 8 | 7 | 3 | 7 | Wave pattern |
| | | | | polishing on |
| | | | | orbital |
| | | | | surface |
| 7 | 6 | 4 | 7 | Pitting |
| | | | | surface, |
| | | | | scratch, |
| | | | | fine |
| | | | | scratch, |
| | | | | focused etch |
| | | | | pit |
| 2 | 7 | 5 | 5 | Pitting |
| | | | | surface, |
| | | | | scratch, |
| | | | | fine |
| | | | | scratch, |
| | | | | focused etch |
| | | | | pit |
| 3 | 9 | 3 | 1 | Pitting |
| | | | | surface, |
| | | | | scratch, |
| | | | | fine |
| | | | | scratch, |
| | | | | focused etch |
| | | | | pit |
| 7 | 6 | 4 | 7 | Fine pitting |
| 9 | 2 | 5 | 5 | Fine pitting |
| 3 | 1 | 3 | 1 | Fine pitting |
| 8 | 2 | 4 | 7 | Wear |

<Combination of Code Values of Fault Type and Fault Occurrence Condition of Gear>

| Fabrication | | | | |
|---|---|---|---|---|
| and | | | Environment | |
| installation | Load | Lubrication | and operation | |
| condition | condition | condition | condition | Fault type |
| 10 | 9 | 6 | 7 | Fine |
| | | | | abrasion, |
| | | | | abrasive wear |
| 3 | 9 | 3 | 1 | Fine |
| | | | | abrasion, |
| | | | | abrasive wear |
| 3 | 3 | 1 | 7 | Normal wear |
| 1 | 2 | 2 | 1 | Normal wear |
| 2 | 4 | 4 | 2 | Excessive |
| | | | | wear |
| 5 | 2 | 1 | 1 | Excessive |
| | | | | wear |
| 6 | 6 | 2 | 1 | Excessive |
| | | | | wear |
| 7 | 6 | 2 | 1 | Excessive |
| | | | | wear |
| 2 | 4 | 4 | 7 | Abrasive |
| | | | | wear, |
| | | | | adhesion wear |
| 5 | 2 | 2 | 1 | Abrasive |
| | | | | wear, |
| | | | | adhesion wear |
| 7 | 6 | 1 | 2 | Abrasive |
| | | | | wear, |
| | | | | adhesion wear |
| 3 | 8 | 5 | 5 | Corrosive |
| | | | | wear |
| 4 | 2 | 4 | 4 | Corrosive |
| | | | | wear |
| 8 | 4 | 3 | 7 | Corrosive |
| | | | | wear |
| 3 | 5 | 4 | 7 | Focused etch |
| | | | | pit |
| 8 | 2 | 1 | 1 | Focused etch |
| | | | | pit |
| 5 | 6 | 2 | 1 | Focused etch |
| | | | | pit |
| 2 | 4 | 4 | 7 | Medium |
| | | | | scratch |
| 5 | 2 | 3 | 1 | Medium |
| | | | | scratch |
| 7 | 6 | 1 | 1 | Medium |
| | | | | scratch |
| 2 | 4 | 4 | 2 | Destructive |
| | | | | scratch |
| 5 | 1 | 2 | 4 | Destructive |
| | | | | scratch |
| 6 | 2 | 1 | 5 | Destructive |
| | | | | scratch |
| 7 | 2 | 1 | 5 | Destructive |
| | | | | scratch |
| 7 | 5 | 4 | 4 | Local scratch |
| 3 | 1 | 3 | 3 | Local scratch |
| 1 | 2 | 1 | 1 | Local scratch |
| 7 | 4 | 4 | 3 | Interference |
| | | | | between tip |
| | | | | end and tooth |
| | | | | root |
| 5 | 2 | 1 | 2 | Interference |
| | | | | between tip |
| | | | | end and tooth |
| | | | | root |
| 3 | 1 | 2 | 7 | Interference |
| | | | | between tip |
| | | | | end and tooth |
| | | | | root |
| 3 | 6 | 2 | 7 | Interference |
| | | | | between tip |
| | | | | end and tooth |
| | | | | root |
| 8 | 8 | 4 | 6 | Initial etch |
| | | | | pit, |
| | | | | corrective |
| | | | | etch pit |
| 4 | 3 | 1 | 1 | Initial etch |
| | | | | pit, |
| | | | | corrective |
| | | | | etch pit |
| 10 | 2 | 3 | 7 | Initial etch |
| | | | | pit, |
| | | | | corrective |
| | | | | etch pit |
| 9 | 1 | 6 | 7 | Gear |
| | | | | resonance, |
| | | | | gear box |
| | | | | resonance |
| 5 | 6 | 6 | 7 | Gear |
| | | | | resonance, |
| | | | | gear box |
| | | | | resonance |
| 6 | 2 | 3 | 7 | Gear |
| | | | | fractional |
| | | | | vibration |

<Combination of Code Values of Fault Type and Fault Occurrence Condition of Pump>

| Fabrication | | | | |
|---|---|---|---|---|
| and | | | Environment | |
| installation | Load | Lubrication | and operation | |
| condition | condition | condition | condition | Fault type |
| 1 | 2 | 3 | 1 | Deficient |
| | | | | discharge |
| | | | | flow rate |
| 5 | 5 | 4 | 2 | Deficient |
| | | | | discharge |
| | | | | flow rate |
| 2 | 4 | 5 | 4 | Deficient |
| | | | | discharge |
| | | | | flow rate |
| 7 | 1 | 3 | 5 | No intake |
| | | | | loss, no |
| | | | | discharge |
| | | | | flow rate |
| 5 | 5 | 5 | 7 | No intake |
| | | | | loss, no |
| | | | | discharge |
| | | | | flow rate |
| 2 | 6 | 8 | 8 | No intake |
| | | | | loss, no |
| | | | | discharge |
| | | | | flow rate |
| 1 | 4 | 3 | 2 | Pump flow |
| | | | | rate pulse |
| 3 | 5 | 5 | 6 | Pump flow |
| | | | | rate pulse |
| 6 | 7 | 6 | 6 | Pump flow |
| | | | | rate pulse |
| 1 | 3 | 8 | 3 | Excessive |
| | | | | flow rate |
| 2 | 3 | 8 | 3 | Excessive |
| | | | | flow rate |
| 2 | 9 | 3 | 1 | Excessive |
| | | | | vibration and |
| | | | | noise |
| 5 | 8 | 5 | 2 | Excessive |
| | | | | vibration and |
| | | | | noise |
| 6 | 7 | 6 | 2 | Excessive |
| | | | | vibration and |
| | | | | noise |
| 8 | 7 | 6 | 2 | Excessive |
| | | | | vibration and |
| | | | | noise |
| 2 | 1 | 3 | 3 | Pump overheat |
| 5 | 5 | 5 | 5 | Pump overheat |
| 6 | 2 | 6 | 6 | Pump overheat |
| 1 | 5 | 3 | 5 | Pump start |
| | | | | defect |
| 10 | 10 | 5 | 6 | Pump start |
| | | | | defect |
| 4 | 3 | 6 | 5 | Stop during |
| | | | | operation |
| 8 | 5 | 5 | 6 | Stop during |
| | | | | operation |
| 10 | 6 | 3 | 6 | Stop during |
| | | | | operation |
| 2 | 1 | 5 | 3 | Excessive |
| | | | | power |
| | | | | consumption |
| 3 | 2 | 6 | 5 | Excessive |
| | | | | power |
| | | | | consumption |
| 5 | 5 | 3 | 5 | Excessive |
| | | | | power |
| | | | | consumption |
| 7 | 10 | 8 | 6 | Reverse |
| | | | | rotation of |
| | | | | pump |
| 7 | 10 | 8 | 5 | Reverse |
| | | | | rotation of |
| | | | | pump |
| 5 | 1 | 5 | 5 | Unstable pump |
| | | | | start |
| 8 | 2 | 6 | 6 | Unstable pump |
| | | | | start |
| 2 | 5 | 3 | 6 | Unstable pump |
| | | | | start |
| 3 | 1 | 3 | 2 | Excessive |
| | | | | impeller wear |
| 5 | 7 | 5 | 8 | Excessive |
| | | | | impeller wear |
| 2 | 7 | 5 | 3 | Excessive |
| | | | | impeller wear |
| 1 | 1 | 1 | 3 | Short bearing |
| | | | | life |
| 5 | 2 | 3 | 8 | Short bearing |
| | | | | life |
| 6 | 8 | 5 | 2 | Short bearing |
| | | | | life |

<Combination of Code Values of Fault Type and Fault Occurrence Condition of Reciprocating Compressor>

| Fabrication | | | | |
|---|---|---|---|---|
| and | | | Environment | |
| installation | Load | Lubrication | and operation | |
| condition | condition | condition | condition | Fault type |
| 2 | 2 | 8 | 1 | Low pressure |
| 1 | 8 | 5 | 8 | Low pressure |
| 3 | 9 | 4 | 9 | Low pressure |
| 10 | 3 | 2 | 2 | Compressor |
| | | | | overheat |
| 7 | 1 | 7 | 7 | Compressor |
| | | | | overheat |
| 2 | 4 | 4 | 9 | Compressor |
| | | | | overheat |
| 2 | 4 | 9 | 9 | Compressor |
| | | | | overheat |
| 6 | 3 | 4 | 9 | Excessive |
| | | | | vibration and |
| | | | | noise |
| 4 | 6 | 8 | 5 | Excessive |
| | | | | vibration and |
| | | | | noise |
| 7 | 6 | 8 | 5 | Excessive |
| | | | | vibration and |
| | | | | noise |
| 5 | 7 | 9 | 10 | Excessive |
| | | | | vibration and |
| | | | | noise |
| 5 | 9 | 9 | 10 | Excessive |
| | | | | vibration and |
| | | | | noise |
| 8 | 7 | 9 | 10 | Excessive |
| | | | | vibration and |
| | | | | noise |
| 8 | 9 | 9 | 10 | Excessive |
| | | | | vibration and |
| | | | | noise |
| 10 | 3 | 2 | 7 | High |
| | | | | discharge |
| | | | | temperature |
| 1 | 8 | 4 | 8 | High |
| | | | | discharge |
| | | | | temperature |
| 2 | 9 | 7 | 9 | High |
| | | | | discharge |
| | | | | temperature |
| 10 | 9 | 8 | 8 | Low |
| | | | | intercooler |
| | | | | pressure |
| 1 | 8 | 10 | 9 | Low |
| | | | | intercooler |
| | | | | pressure |
| 2 | 2 | 10 | 10 | Low |
| | | | | intercooler |
| | | | | pressure |
| 3 | 6 | 4 | 5 | Knocking of |
| | | | | compressor |
| 4 | 7 | 8 | 10 | Knocking of |
| | | | | compressor |
| 7 | 9 | 9 | 10 | Knocking of |
| | | | | compressor |
| 10 | 10 | 3 | 8 | Excessive oil |
| | | | | consumption |
| 10 | 10 | 2 | 7 | Excessive oil |
| | | | | consumption |
| 10 | 10 | 5 | 10 | Excessive oil |
| | | | | consumption |
| 10 | 10 | 10 | 8 | Safety belt |
| | | | | fault |
| 10 | 10 | 10 | 10 | Safety belt |
| | | | | fault |
| 2 | 5 | 4 | 3 | Ignition |
| | | | | defect |
| 10 | 10 | 10 | 5 | Ignition |
| | | | | defect |
| 10 | 10 | 10 | 6 | Ignition |
| | | | | defect |
| 2 | 6 | 2 | 2 | Wear of |
| | | | | piston ring, |
| | | | | cylinder, and |
| | | | | valve |
| 1 | 7 | 4 | 8 | Wear of |
| | | | | piston ring, |
| | | | | cylinder, and |
| | | | | valve |
| 10 | 10 | 6 | 10 | Wear of |
| | | | | piston ring, |
| | | | | cylinder, and |
| | | | | valve |
| 10 | 10 | 8 | 10 | Wear of |
| | | | | piston ring, |
| | | | | cylinder, and |
| | | | | valve |
| 1 | 3 | 8 | 7 | High coolant |
| | | | | discharge |
| | | | | temperature |
| 2 | 4 | 9 | 8 | High coolant |
| | | | | discharge |
| | | | | temperature |

As described above, the fault type and the degree of fault according to the state information on the fault occurrence condition inputted from the user are determined (S160) by combining the code values stored in the database.

In the fault occurrence condition, relevant fault occurrence conditions are grouped, and when corresponding status information is inputted in the first fault occurrence condition, only the contents related to the condition selected in the previous step are displayed in the fault occurrence condition of the next step.

In a next step, the conditions related to the combination of all the conditions selected in the previous step are displayed.

Hereinafter, the fault prediction method according to the fault occurrence condition inputted from the user as described in the above manner will be described in detail.

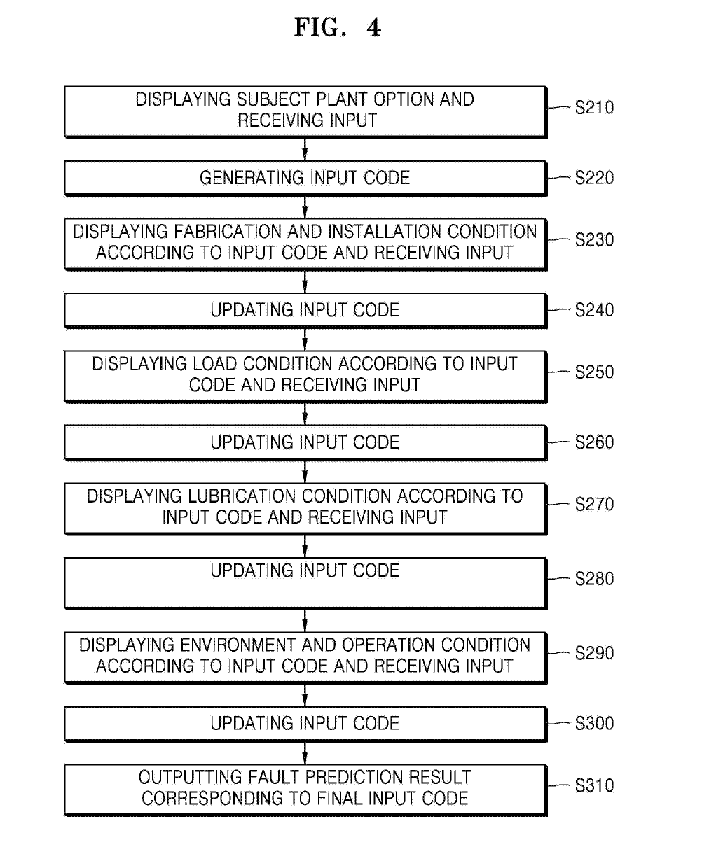

FIG. 4 is a flowchart illustrating a process for receiving a fault occurrence condition according to the present invention.

Referring to the drawings, combined values of the fault types and the fault occurrence conditions of each rotary machine elements are stored in a plant information database.

First, the subject plant is selected for predicting the plant defect (S210). State information on the fabrication and installation condition, the load condition, the lubrication condition, and the environment and operation condition are sequentially received (S210-S290). A result of predicting the fault is stored and outputted based on the combination (S300-S310).

Herein, the status information on the fault occurrence condition is inputted according to the fault occurrence sequence of the machine elements.

The fabrication and installation condition capable of figuring out the defects on design and fabrication are firstly determined in drawings before the operation of the plant (S230), and then the load condition for the problem of noises, vibration, or the like during the operation of the plant (S250). Next, the lubrication condition due to abrasion of the rotary machine element, foreign matter penetration, viscosity defect or the like after operation for a predetermined time is determined (S270). Finally, the environment and operation condition according to operation speed or operation time is inputted (S290).

In other words, the subject plant is selected (A1), the fabrication and installation condition suitable for the conditions of the subject plant (A1) is extracted, and the fabrication and installation condition (B1) is selected in association with the combination of the subject plant (A1).

Next, in the load condition, only the conditions related to the previous combination (A1B1) are extracted. Then, in the lubrication condition selection, only the conditions related to the previous combination (A1B1C1) are extracted as in the load condition. Finally, the fault type is predicted.

Specifically, the fault prediction system displays subject plant options and receives a user input (S210). Then, the fault prediction system generates an input code according to the user input (S220). For example, subject plant options are A1, A2, and A3, and the input code is generated as “A1” if user selects A1.

Then, the fault prediction system displays fabrication and install conditions according to the previous input code “A1”, and receives an user input (S230). Then, the fault prediction system updates the input code (s240). For example, fabrication and install conditions subject plant options are B1, B2, and B3, and the input code is updated as “A1B1” if user selects B1.

Then, the fault prediction system displays load conditions according to the previous input code “A1B1”, and receives a user input (S250). Then, the fault prediction system updates the input code (s260). For example, load conditions are C1, C2, and C3, and the input code is updated as “A1B1C1” if user selects C1.

Then, the fault prediction system displays lubrication conditions according to the previous input code “A1B1C1”, and receives a user input (S270). Then, the fault prediction system updates the input code (s280). For example, load conditions are D1, D2, and D3, and the input code is updated as “A1B1C1D1” if user selects D1.

Then, the fault prediction system displays environment and operation conditions according to the previous input code “A1B1C1D1”, and receives a user input (S290). Then, the fault prediction system updates the input code (S300). For example, load conditions are E1, E2, and E3, and the input code is updated as “A1B1C1D1E1” if user selects E1.

Nest, the fault prediction system outputs a fault prediction result corresponding to the final input code.

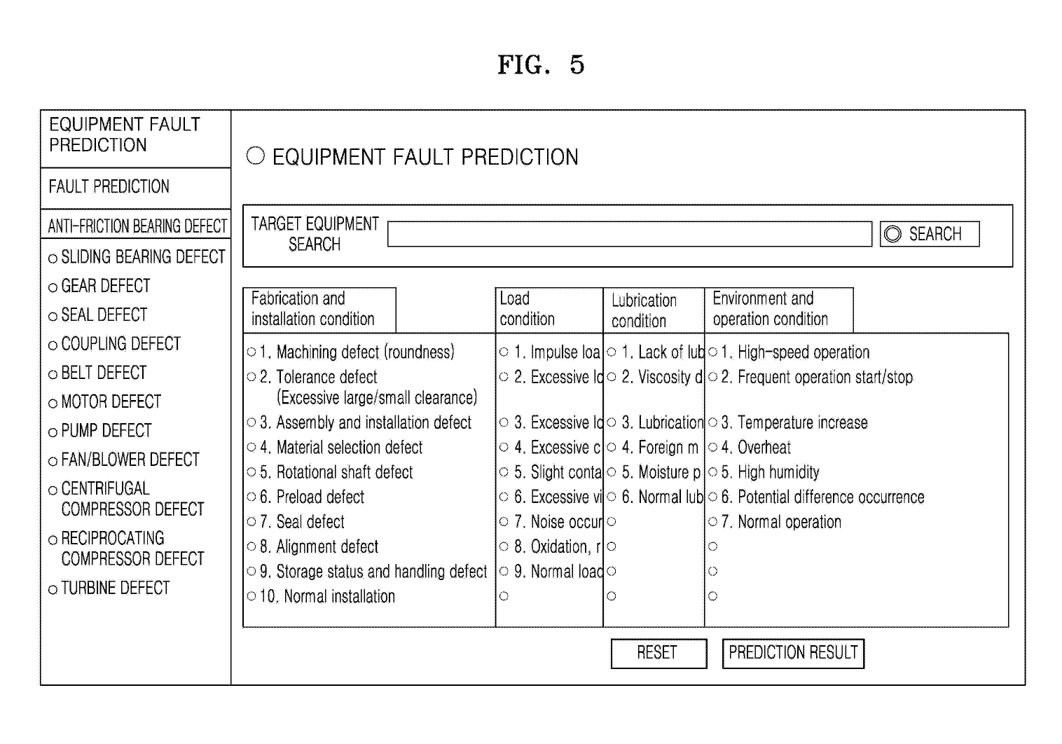

FIG. 5 to FIG. 10 are views illustrating examples of a fault prediction sequence of an anti-friction bearing according to combinations of fault occurrence conditions.

First, when the anti-friction bearing is selected to predict the fault, all state information that can be inputted are displayed in a tab of the fabrication and installation condition, as shown in FIG. 5.

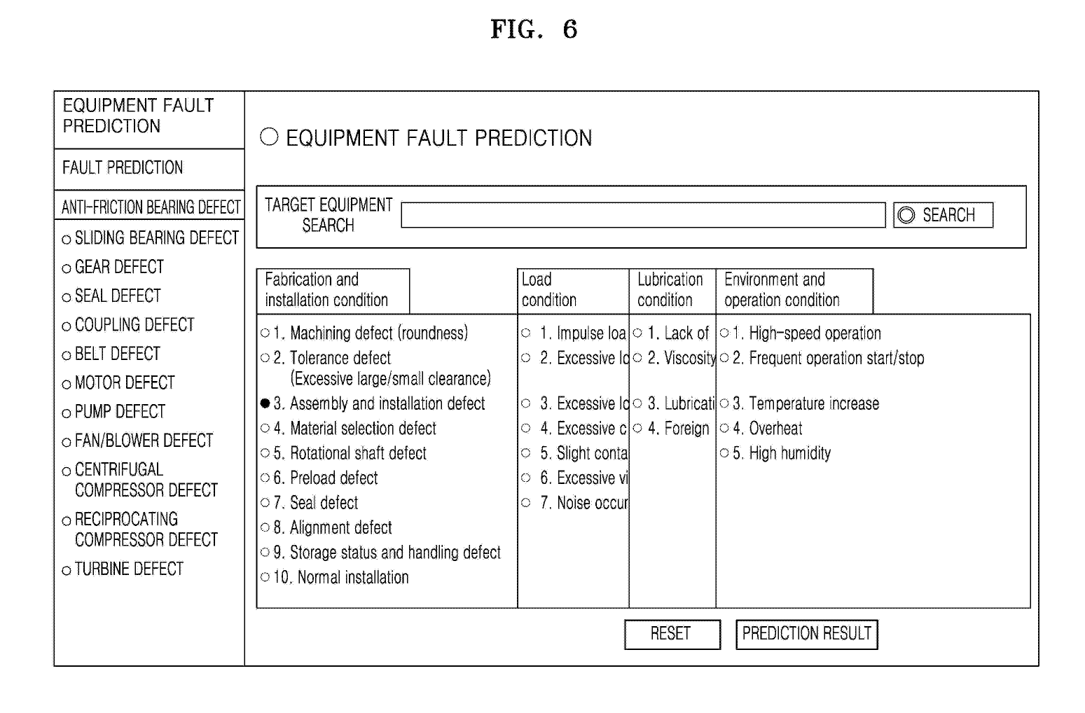

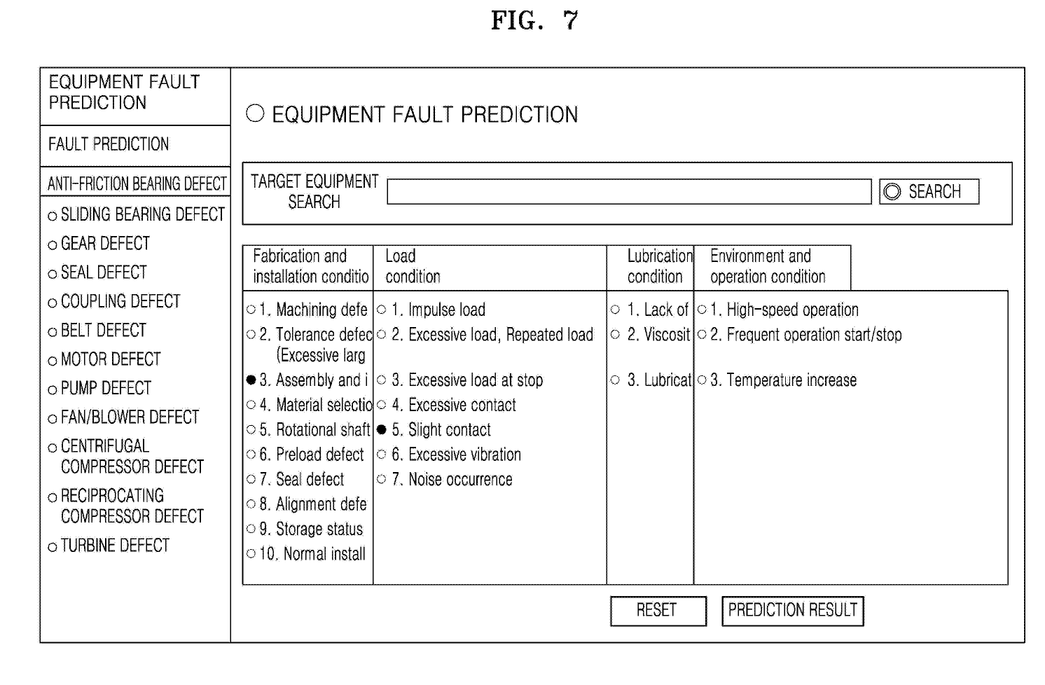

In addition, as shown in FIG. 6, when the user selects the status information indicating “3. assembly and installation defect” among the fabrication and installation condition, only the state information on the load condition related to the assembly and installation defect are displayed in FIG. 7.

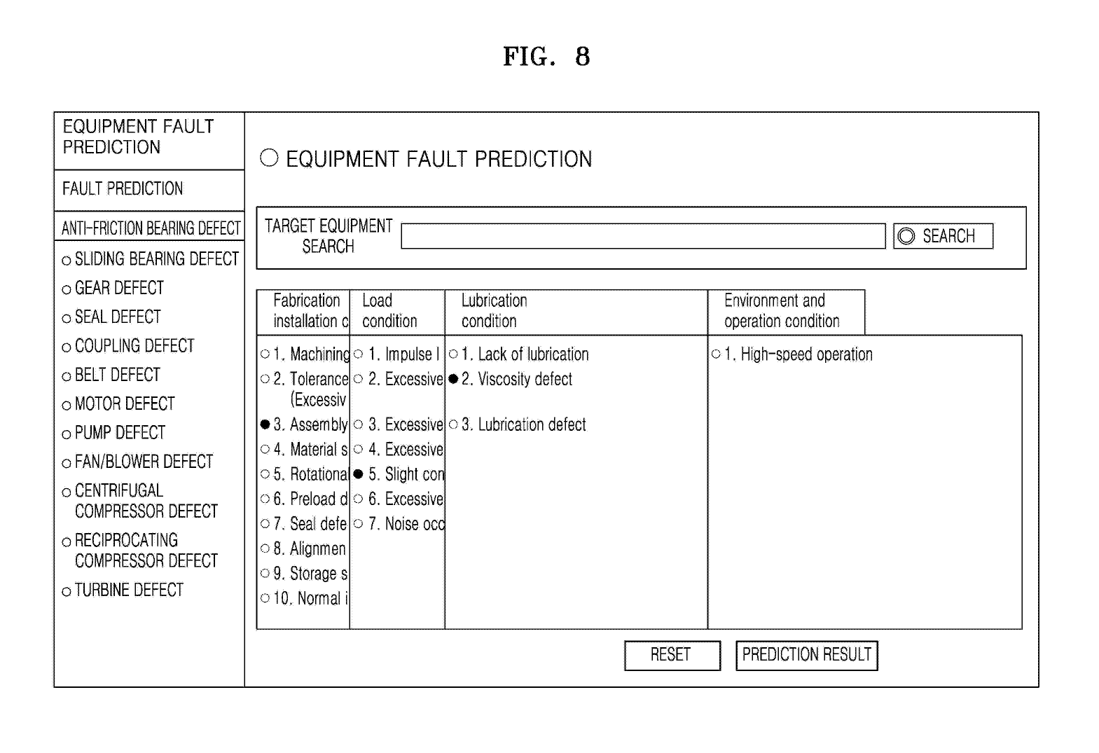

In addition, when the user selects the state information indicating “5. excessive vibration in the load condition in FIG. 7, the state information on the lubrication condition is displayed according to the combination of the No. 3 state information selected in the fabrication and installation condition and the No. 5 state information selected in the load condition, as shown in FIG. 8.

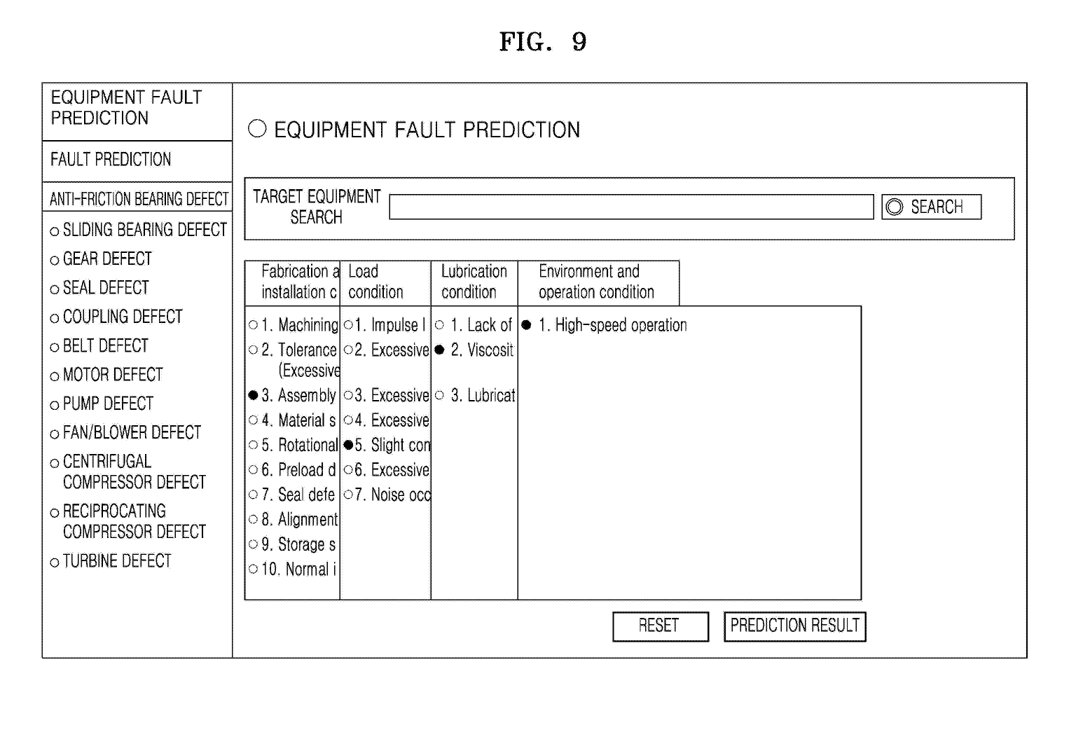

Then, as shown in FIG. 9, the status information on the environment and operation condition is displayed after combining the No. 2 state information selected in the lubrication condition with information in the previous step.

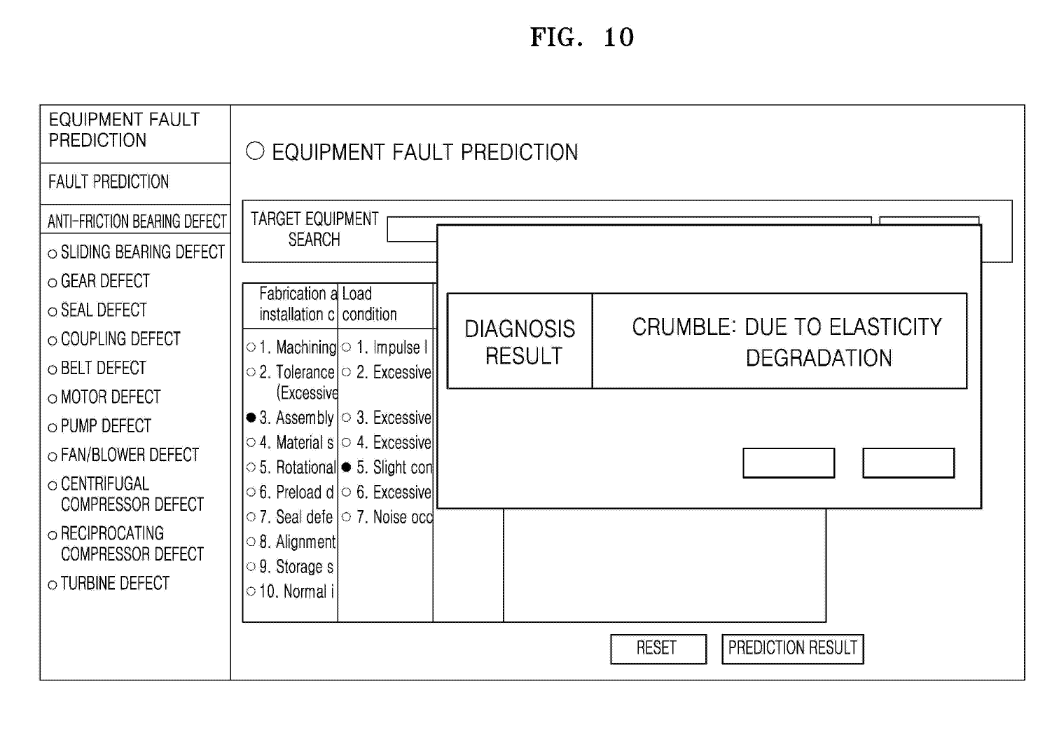

Finally, as shown in FIG. 10, when the status information on the environmental and operation condition is inputted, the result of predicting the fault of the anti-friction bearing is finally displayed, and the result may be stored or outputted.

The present invention has been described in connection with the above-mentioned preferred embodiments, however, various modifications and variations are available without departing from the spirit and scope of the invention.

Therefore, it shall be understood that the appended claims cover the modifications and variations within the scope of the invention.

What is claimed is:

1. A computer-implemented method for predicting a plant fault, the method comprising:
a first step of receiving definitions for rotary machine elements for predicting a fault among plant components;
a second step of receiving definitions for fault types and fault occurrence conditions of each of the rotary machine elements;
a third step of classifying and coding the fault occurrence conditions of each of the rotary machine elements into predetermined categories;
a fourth step of associating the fault type of each rotary machine element with a combination of code values of the fault occurrence conditions and storing the result in a database;
a fifth step of receiving status information on the fault condition of the rotary machine element for predicting a fault from a user; and
a sixth step of determining the fault type corresponding to a combination of the code values of the received fault conditions.

2. The method of claim 1, wherein the predetermined categories comprises a fabrication and installation conditions, a load condition, a lubrication condition, and an environment and operation condition.

3. The method of claim 2, wherein the fifth step comprises:
displaying subject plant options and receiving a user input;
generating an input code according to a previous user input for subject plant options;
displaying fabrication and install conditions according to the previous input code;
updating the input code according to a previous user input for fabrication and install conditions;
displaying load conditions according to the previous input code;
updating the input code according to a previous user input for load conditions;
displaying lubrication conditions according to the previous input code;
updating the input code according to a previous user input for lubrication conditions;
displaying environment and operation conditions according to the previous input code; and
updating the input code according to a previous user input for environment and operation conditions.

4. The method of claim 3, wherein the sixth step comprises determining the fault type according to the final updated input code.
